(19) United States
(12) Patent Application Publication
(10) Pub. No.: US 2007/0124242 A1
(43) Pub. Date: May 31, 2007

(54) FUNDS TRANSFER SYSTEM

(76) Inventor: A. Dennis Reis JR., Daly City, CA (US)

Correspondence Address: IAN F. BURNS & ASSOCIATES, P.O. BOX 71115, RENO, NV, 89570, US

(21) Appl. No.: 11/560,347

(22) Filed: Nov. 15, 2006

Related U.S. Application Data
(60) Provisional application No. 60/737,253, filed on Nov. 15, 2005.

(51) Int. Cl. G06Q 40/00

(52) U.S. Cl. 705/39

(57) ABSTRACT

An international funds transfer system for transferring monetary funds between various countries and currencies. The funds transfer system includes a customer interface system that allows a remitter to create, validate and initiate a remittance transaction A host computer system is in communication with the customer interface system The host computer system is adapted to receive the remittance transaction from the customer interface system and to transmit the remittance transaction to an originating financial institution financial system and a receiving financial institution financial system. The originating financial institution transmits the funds to the receiving financial institution.

### CROSS REFERENCE TO RELATED APPLICATIONS

This application claims priority to U.S. provisional patent application Ser. No. 60/737,253, filed Nov. 15, 2005 and entitled, “Funds Transfer System,” the contents of which are herein incorporated by reference in entirety.

### FIELD OF THE INVENTION

The present invention relates generally to systems and methods of remitting or transferring funds, and more specifically to a system and method of international funds transfer.

### BACKGROUND

A large number of individuals have family, friends and relatives that reside in one or more foreign countries. Frequently, it is desired to send regular portions or installments of their income to various family members. It may also be desired to send bill payments or transact purchases with business in foreign countries.

There are various methods that can be used to transmit funds from one country to another such as money transfer agents like Western Union or bank wire transfers. Unfortunately, these fund transfer methods have many disadvantages that render their use inconvenient, expensive, complex and inefficient.

Specifically, money transfer agents typically require a sender to initiate the process by visiting a physical location. The sender completes a sender's transaction form, specifying the amount of funds being transferred, the transfer destination (foreign country), and information concerning the receiving party. The sender is required to pay the agent the cash equivalent of the transfer amount plus a relatively expensive transaction fee, before the agent will process the transaction.

At the destination location, the receiving party must travel to an office of the money transfer agent, which may or may not be conveniently located. The receiving party must complete a receiver's transaction form that designates the name of the receiving party, relevant contact information of the sender and receiving party, the expected amount of funds, and further information regarding the origination of the funds.

The receiving party must also provide the destination agent with acceptable identification such as driver's license or passport.

Further the receiving party may need to comply with government requirements such as taxes or fees. After confirming the identity of the receiving party, the money transfer agent remits to the receiving party the foreign currency cash equivalent of the transferred amount.

Unfortunately, the use of a money transfer agent has many disadvantages. In addition to the expensive fees charged by the money transfer agent, the sending party must travel to the physical location of the agent and complete the required forms. This procedure is especially time consuming and inconvenient for individuals remitting regular portions of their income to family members. The funds receiving party is also subjected to the inconvenience of traveling to the office of the money transfer agent during the hours that the office is open.

Bank wire transfer systems can readily transfer desired amount of money to other banks worldwide. The use of bank wire transfer systems requires the receiving party to have a bank account in the foreign country in the receiving party's name. Often, low-income parties do not have bank accounts and are unable to receive funds in this manner. Another drawback to conventional bank wire transfer systems is that the systems are set-up to handle large denomination transactions among commercial businesses and as such have large fees associated with each transaction.

Therefore, a current unmet need exists for an improved system and method of international funds transfer that overcomes the inconvenience and delays associated with conventional money transfer services.

### SUMMARY OF THE INVENTION

### Advantages of One or More Embodiments of the Present Invention

The various embodiments of the present invention may, but do not necessarily, achieve one or more of the following advantages:

the ability to provide a person an easier way to send money to foreign countries;

the ability to provide a recipient in a foreign country access to monetary funds;

provide an international funds transfer system that is low in cost;

provide an international funds transfer system that can be accessed by individuals over the internet;

provide a funds transfer system that is suited for repeated remittances;

provide a funds transfer system that can transfer funds between countries and currencies;

the ability to provide a funds transfer system in which the actual monetary funds are not received;

the ability to provide a funds transfer system that can communicate with originating and receiving financial institutions;

These and other advantages may be realized by reference to the remaining portions of the specification, claims, and abstract.

### Brief Description of an Embodiment of the Present Invention

In an embodiment, the present invention relates to a system for transferring monetary funds. The system includes a customer interface system that allows a remitter to create, validate and initiate a remittance transaction A host computer system is in communication with the customer interface system. The host computer system is adapted to receive the remittance transaction from the customer interface system and to transmit the remittance transaction An originating financial institution financial system is in communication with the host computer system. The originating institution financial system receives the transmitted remittance transaction from the host computer system, processes the remittance transaction and transmits the funds. A receiving financial institution financial system is in communication with the host computer system. The receiving institution financial system receives the transmitted remittance transaction from the host computer, receives the funds from the sending financial institution financial system and provides the funds to the beneficiary.

In another embodiment, the present invention relates to a method of transferring monetary funds. The method includes receiving financial account information from a sender. The financial account information includes information about the sender and a recipient. The financial account information is validated. Remittance instructions are received from the sender to initiate a fund transfer transaction Payment instructions are issued to at least one originating financial institution to perform the fund transfer transaction At least one receiving financial institution is notified of the payment instructions associated with the fund transfer transaction The originating financial institution is allowed to transfer the funds to the receiving financial institution

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining one or more embodiments of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1A substantially illustrates a funds transfer computer network according to the present invention.

FIG. 1B substantially illustrates a diagrammatic view of a funds transfer system according to the present invention.

FIG. 2 is substantially a flowchart of the process to set-up and initiate a customer account in the funds transfer system.

FIG. 3 is substantially a flowchart of the process to initiate an international fund transfer event in the funds transfer system.

FIG. 4 is substantially a flowchart of the process to transfer funds between countries in the funds transfer system.

FIG. 5 is substantially a flowchart of the movement of funds being transferred between the sending institutions and the receiving institutions in the funds transfer system.

### DESCRIPTION OF ONE OR MORE EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

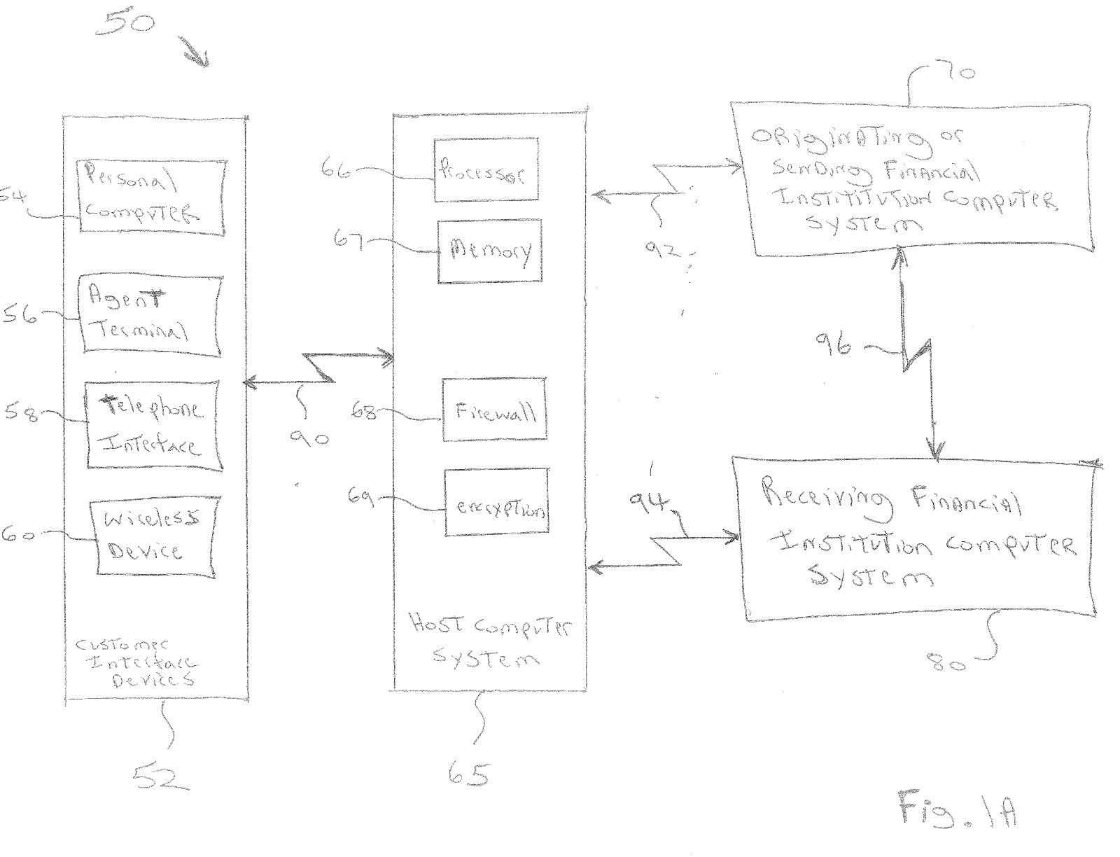

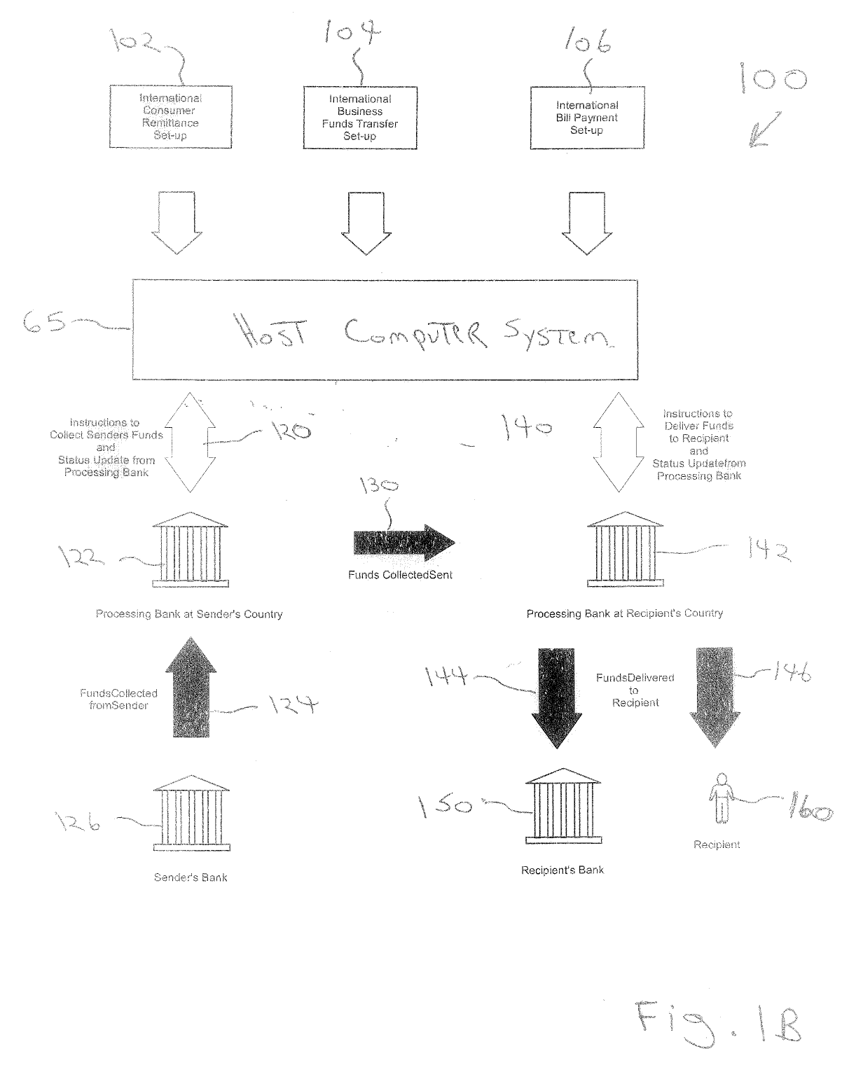

Referring to FIG. 1A, a funds transfer computer network, generally indicated by reference number 50 is shown. Funds transfer computer network 50 can include one or more customer interface systems or devices 52. Customer interface systems or devices 52 can be a wide variety of devices that a customer can use to input and receive information. For example, customer interface device 52 can be a personal computer 54, an agent terminal 56, a telephone interface 58 or a wireless device 60. The customer interface devices allow a customer to communicate with a host computer 65 through a communication network 90.

Communication network 90 can be any possible communication device that allows reliable and secure communications between customer interface devices 52 and host computer system 65. In one embodiment, communication network 90 can be the internet. In this case, a customer would typically use personal computer 54 to access the funds transfer system from a home or an office.

The customer interface devices 52 allow a customer to setup a fund transfer account and to ensure that customers enter the appropriate information and edit the information to ensure compliance with government regulations and business practices.

Software that runs the international funds transfer system can reside on host computer 65. Host computer 65 can include a processor 66, a memory or storage device 67. The software is stored in memory device 67. Host computer 65 may further include other systems to facilitate secure communications such as a firewall system 68 and an encryption engine 69.

Host computer 65 can include various computer components such as various servers, routers and firewalls that can be located at a secure facility. In an embodiment host computer system 65 physically has two application servers whose activity is coordinated by a load balancer and a database server with RAID storage device. The database information is mirrored to ensure that a failure of a disk drive will not result in information being lost. In addition, a mail server can be attached to the server cluster to form host computer system 65.

Host computer 65 is also in communication with one or more originating or sending financial institution financial or computer systems 70 through a communication network 92. Originating or sending financial institution financial or computer system 70 may reside at a bank, credit union, investment company, transfer agent or any other financial intermediary. Communication network 92 can be any possible communication device that allows reliable and secure communications between host computer 65 and originating financial institution computer system 70. For example, communication network 92 can be a secure real time communication network such as a wide area network or the internet or a batch transmission.

Host computer 65 is also in communication with one or more receiving financial institution financial or computer systems 80 through a communication network 94. Receiving financial institution financial or computer system 80 may reside at a bank, credit union, investment company, transfer agent, courier service or any other financial intermediary. Communication network 94 can be any possible communication device that allows reliable and secure communications between host computer 65 and receiving financial institution computer system 80. For example, communication network 94 can be a secure real time communication network such as a wide area network or the internet or a batch transmission.

Originating financial institution computer system 70 can further be in communication with receiving financial institution computer system 80 through a communication network 96. Communication network 96 can be any possible communication device that allows reliable and secure communications between originating financial institution computer system 70 and receiving financial institution computer system 80. Communication network 96 can be a secure real time communication network such as a wide area network or the internet or a batch transmission.

With reference to FIG. 1B, an international funds transfer system or process, generally indicated by reference number 100 is shown. International funds transfer system 100 can include software which directly interfaces with customers through customer-facing software applications such as international consumer remittance software 102, international business transfers software 104, international bill payments software 106, and other customer-facing software applications. These software applications run on host computer system 65.

These customer facing applications assist the customer in setting-up financial accounts from which monetary funds will be sent and recipients who will receive the funds. These applications ensure that customers enter the appropriate information and edit the information to ensure compliance with regulations and business practices in both the sender's and recipient's countries. The information is then validated systematically against industry databases or validated manually to ensure accuracy of the information. Once validated the information is stored for use by the customer to initiate transfers.

Once information has been validated, the customer is able to initiate a transfer by merely choosing a financial account and a recipient. The customer then enters the amount to send. Once the customer confirms the transfer, the international transfer process takes the transfer information and sends instructions 120 electronically to processing banks 122 to collect the senders' funds 124. Acting on these instructions, the processing banks 122 collect funds from an originating or sending bank 126 and immediately forwards these funds to the processing banks 122 in order to deliver the funds being transferred. The funds collected 130 are then sent electronically to a receiving processing bank 142 in the recipients country

The international funds transfer system 100 may also send instructions 140 electronically to receiving processing banks 142 to deliver funds 146 to the recipient 160 or deliver funds 144 to a recipient bank 150. The international funds transfer system 100 can also exchange currencies and calculate the exchange amounts as will be detailed later.

It is noted that funds transfer system 100 functions as a third party enabler by giving instructions to the originating and receiving financial institutions to exchange funds. Funds transfer system 100 never receives or takes possession of any of the monetary funds being transferred. Because funds transfer system 100 does not receive any monetary funds, the funds transfer system is not subject to the same regulations that a banking institution would be.

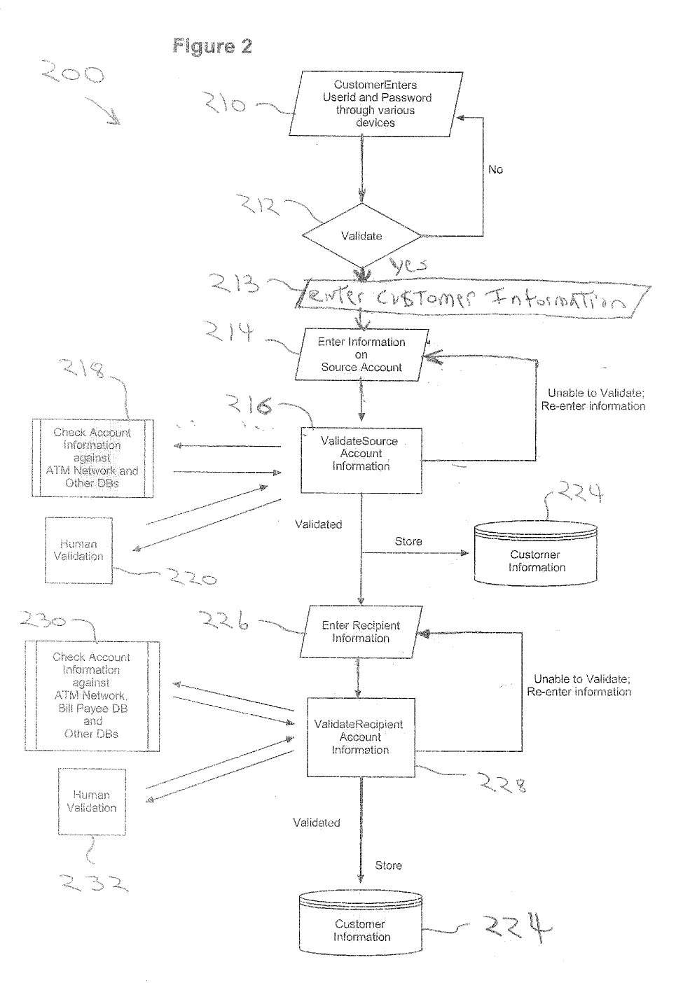

Referring now to FIG. 2, a process or method 200 of establishing or creating an account on the funds transfer system 100 is shown. Prior to initiating a transfer of funds, a sending customer must create and store a source account and recipient information with the pertinent information that is needed by the initial and subsequent fund transfers.

A sending customer would link to the funds transfer system website using a personal computer in order to log-in and create an account. Alternatively, a customer could use a dedicated terminal at the office of an agent or may be able to access the funds transfer system over another communication system such as through a wireless device like a cell phone.

Method 200 may include an initial step of logging into a host computer network 65 or system at step 210. In step 210, the funds transfer system would present the customer with a web screen that would allow the customer to enter the appropriate user-id and password. The user-id and password may have been previously issued to the customer in an e-mail. Alternately, the computer network may direct new users or customers to alternative web screens to obtain a user-id and password.

The user-id and password can be validated at step 212. If the user-id and password are incorrect, method 200 returns to step 210 to allow the customer to re-enter the correct user-id and password. If the user-id and password are correct, method 200 proceeds to step 213.

At step 213, the customer can enter personal information about themselves such as name, address, phone number, social security number, driver's license number, passport number, date of birth and any other information that may be required to establish an account.

At step 214, the customer can enter information about the financial accounts he wishes to use as the source of the funds (also called source accounts) that will be the source of the funds being transferred. A new web screen may be presented to enter this information. The customer can enter the following information for checking, savings and investment accounts—bank name, swift code, bank routing number, account number; or if debit or credit card, card number, security code and expiration date.

If the customer is setting up an account to transfer funds for business purposes or to pay bills internationally or for any other reason, additional information may be requested depending on the business practice and regulations of the customer's country. This additional information may include the tax identification number of the sender, the business address of the sender, and other information. Determining what specific information may be required is based on the sender's country's business practices and regulations and are embedded in the business rules that may be part of the fund transfer system or may be an external service accessed by the system. Additional web screens may be shown to allow the customer to enter the additional information.

Next, method 200 validates the authenticity of the source account information at step 216. The account information is validated by communicating with the source automated teller machine (ATM) networks 218 or by querying bank databases 218 to determine whether the account number is valid, the account is open, if there are any restrictions to the account and any other information required to validate the source account.

If the sender's country does not have an automated system for validating an account, a manual validation process 220 may be employed. If the account is not validated, method 200 returns to step 214 and the customer is requested to re-enter a different source account. If the source account is valid, method 200 stores the customer information and source account information in the customer account database 224.

Next at step 226, the customer enters information about the recipient or receiver of the monetary funds. A new web screen may be presented to the customer for entering the recipient information. The recipient information can include the recipients name, address, contact information, recipient's bank name (if any), recipient's bank account number (if any), and any other required information.

If the customer is planning to transfer funds for business purposes or to pay bills internationally or for any other reason, additional information may be requested depending on the business practice and regulations of the recipient's country. This additional information may include the tax identification number of the recipient, the customer's account number, the invoice number, and other information. Determining what specific information may be required is dependent on the business practice and regulations of the recipient's country and may be embedded in the business rules that are part of the system software or may be accessed by the system from an external service.

Next, funds transfer system 100 validates the authenticity of the recipient account information at step 228. The funds transfer systems validates the authenticity of the recipient account by communicating with recipient automated teller machine (ATM) networks 230 and banking databases 230 to determine whether the recipient account number is valid, the account is open and if there are any restrictions to the account.

If the recipient's country does not have an automated system for validating an account or if the recipient does not have a bank account, a manual process 232 may be employed. If the recipient account is not validated, method 200 returns to step 226, where the customer is requested to enter a different recipient. If the recipient account is valid, method 200 stores the recipient account information in the customer account database 224.

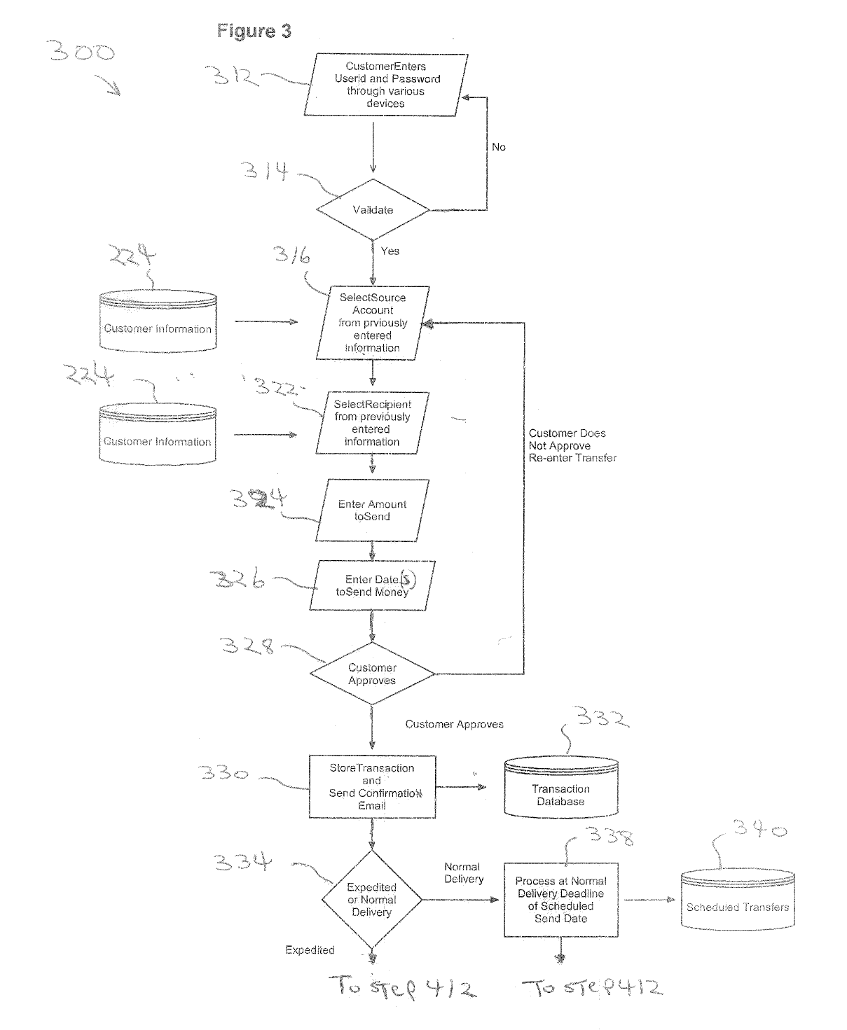

Turning now to FIG. 3, a process or method 300 of initiating or starting an international transfer of funds is shown. Method 300 may be performed immediately after an account has been established and validated in method 200.

Alternatively, the customer may return at a later date to perform a fund transfer. In this case, the customer would skip method 200 and proceed directly to method 300.

At step 312, the funds transfer system would present the customer with a web screen that would allow the customer to enter the appropriate user-id and password in order to log into the fund transfer system.

The user-id and password can be validated at step 314. If the user-id and password are incorrect, method 300 returns to step 312 to allow the customer to re-enter the correct user-id and password. If the user-id and password are correct, method 300 proceeds to step 316.

A customer may initiate or start a money transfer at step 316. The customer selects a source account from the validated list of source accounts that were previously created and stored in customer account database 224. At step 322, the customer selects a recipient account from the validated list of recipient accounts that were previously created and stored in customer account database 224. Appropriate web screens to allow the selection of source accounts and recipient accounts are generated by host computer system 65 and presented to the customer.

The customer is prompted to enter the amount of money to be sent at step 324 and the date for the money transfer to take place in step 328. The amount of money to be transferred that is entered can be either in the sender's currency or in the recipient's currency. Host computer system 65 can synchronize money transfer dates across various time zones and international date lines. The processing date and time of the funds transfer is set to synchronize the business days of the senders and recipients' countries and in order to minimize the time delay involved in transferring funds internationally.

At step 328, the customer is presented with a web screen that displays the previously entered source account, recipient account, amount of money to be transferred and transfer date and is asked to approve these selections. The customer is requested to confirm that they wish to initiate a fund transfer transaction and the transfer information. If the customer does not approve the previously entered information or desires to make changes, method 300 returns to step 316 to allow the customer to re-enter the source account, recipient account, amount of money to be transferred and transfer date. If the source account, recipient account, amount of money to be transferred and transfer date are correct and approved by the customer, method 300 proceeds to step 330.

At step 330, the fund transfer or remittance transaction information is stored by host computer system 65 into a transaction database 332. An e-mail confirming the remittance transaction is also sent to the customer by host computer system 65 at step 330.

A delivery type is specified at step 334 by the customer. An appropriate web screen is displayed to the customer for entry of the delivery type. Typically, the deliver types would include options on how quickly the funds transfer is to occur. For example, the delivery types can include expedited delivery (i.e. the fund transfer is delivered in 1 business day) or normal delivery. An extra charge may be made for expedited delivery. This charge would be displayed to the customer at this time.

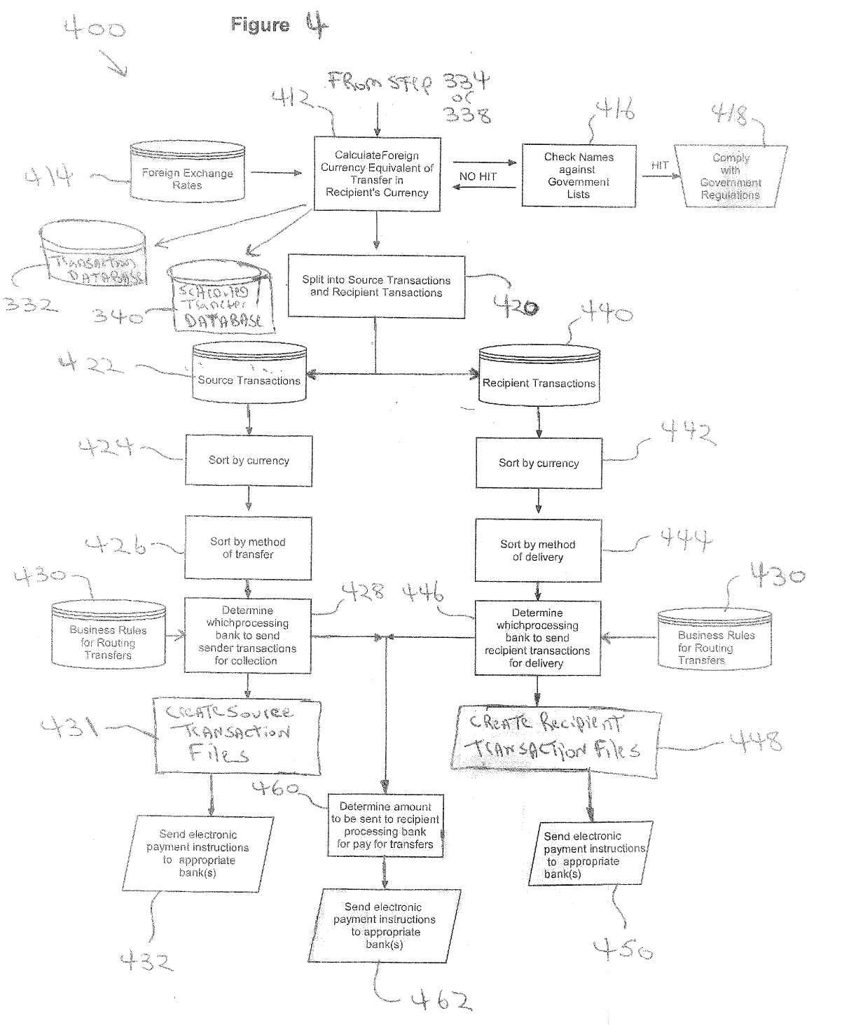

If the selected delivery type is expedited delivery, the fund transfer transaction is immediately sent for transfer processing to step 412 of FIG. 4. If the selected delivery type is normal delivery, method 300 proceeds to step 338, where the fund transfer transaction is processed on the date scheduled by the customer. Also at step 338, the fund transfer or remittance transaction information and delivery type is stored by host computer system 65 into a scheduled fund transfers database 340.

With reference now to FIG. 4, a process or method 400 of transferring funds internationally is shown. After step 338, (FIG. 3), the next step performed host computer system 65 is to convert the amount of the sender's currency into the amount of the recipient's currency at step 412. The foreign exchange rates used in step 338 to convert the sender's currency to a recipient's currency are loaded daily into a foreign exchange rate data base 414 or may be accessed from a service external to the funds transfer system 100. The fund transfer amount in the recipient's currency is also stored in transaction database 332 and scheduled transfers database 340 at step 412.

Method 400 next proceeds to step 416 where the names of the sender and the recipient are then compared with the names on various international/national terrorist and money laundering lists to see if an individuals or business are prohibited from making monetary transfers within or between countries. These lists would be generated by the sending country government, the receiving country government or both.

Historical transfer patterns are scrutinized to determine if the sender is attempting to evade government restrictions. This risk management process may be embedded in the software of funds transfer system 100 or may be an external system that is accessed for this purpose.

At step 420, the fund transfer transaction information is split into two individual transactions, a source transaction and a recipient transaction. The source transaction incorporates the sender's information, such as name, bank routing number, bank account number, credit/debit card number, amount transferred in both sending and receiving currency, and other pertinent information. The source transaction information is stored into a source transaction database 422.

The recipient transaction incorporates recipient information such as the recipient name, address, bank name, bank account number, amount to be delivered in the remitter's currency, the country, the method of delivery, and other pertinent information required by the recipient's country's business practices and banks. The recipient transaction information is stored into a recipient transaction database 440.

Method 400 then proceeds to step 424 where the source transaction database 422 information is sorted by delivery currency and then to step 426 where the source transaction information is sorted by the method of transferring funds from the source accounts. After the sorting at steps 424 and 426 are completed, the fund transfer system software on the host computer applies business rules that are stored in a business rules database 430 to each group of sorted source transactions to determine to which processing bank a source transaction is routed to for collection at step 428.

The system software then creates a file of all source transactions to be routed to a processing bank(s) for collection at step 431. For example, one source transaction file in US Dollars may be created for transfers as debit to a bank account and another source transaction file may be created for transfers as credit card transactions. One of the source transaction files can be assigned to Bank A for processing and the other source transaction file can be assigned to Bank B for processing.

The source transactions are converted to a transaction format and file format at step 431 that each processing bank(s) requires. The file format used may be the processing bank's proprietary format, a standard format used by the banks in that country, an international banking format, or any other suitable file format. The source transaction files are sent electronically at step 432 to the processing bank by a secure real time communication network such as a wide area network or the internet or by batch transmission or by any suitable electronic communication means.

After the source transaction files are received by the processing bank(s), the processing bank(s) will collect funds from the source accounts using the most efficient and least costly method of collecting funds for that type of financial account. These can include the local electronic funds transfer system, wire transfer, electronic checks, ATM/debit card network, credit card network, automated clearing house (ACH) and any other means to efficiently collect funds.

After the recipient transaction has been generated at step 420, method 400 then proceeds to step 442 where the recipient transaction database 440 information is sorted by delivery currency and then to step 444 where the recipient transaction information is sorted by the method of delivery.

After the sorting at steps 442 and 444 are completed, the fund transfer system software on the host computer applies business rules that are stored in a business rules database 430 to each group of sorted recipient transactions to determine to which processing bank a recipient transaction is routed to for delivery at step 446.

The system software then creates a file of all recipient transactions to be routed to a processing bank(s) for delivery at step 448. For example, one recipient transaction file may be created in Philippine Pesos to credit to a bank account and another recipient transaction file may be created in Philippine Pesos as courier delivery of cash.

The recipient transactions are converted to a transaction format and file format at step 448 that each processing bank(s) requires. The file format used may be the processing bank's proprietary format, a standard format used by the banks in that country, an international banking format, or any other suitable file format.

The recipient transaction files are sent electronically at step 450 to the delivery bank(s) by a secure real time communication network such as a wide area network or the internet or by batch transmission or by any suitable electronic communication means.

Method 400 proceeds next to step 460. At step 460, the system software determines the amount of processing fees to be sent to the delivery or recipient banking institutions to pay for the transfers. A reporting file containing the processing fee information is generated and is sent to the sending or collecting bank at step 462. The reporting file instructs the collecting processing bank to forward the funds collected for the processing fees to the account of the receiving bank delivering funds to the recipient.

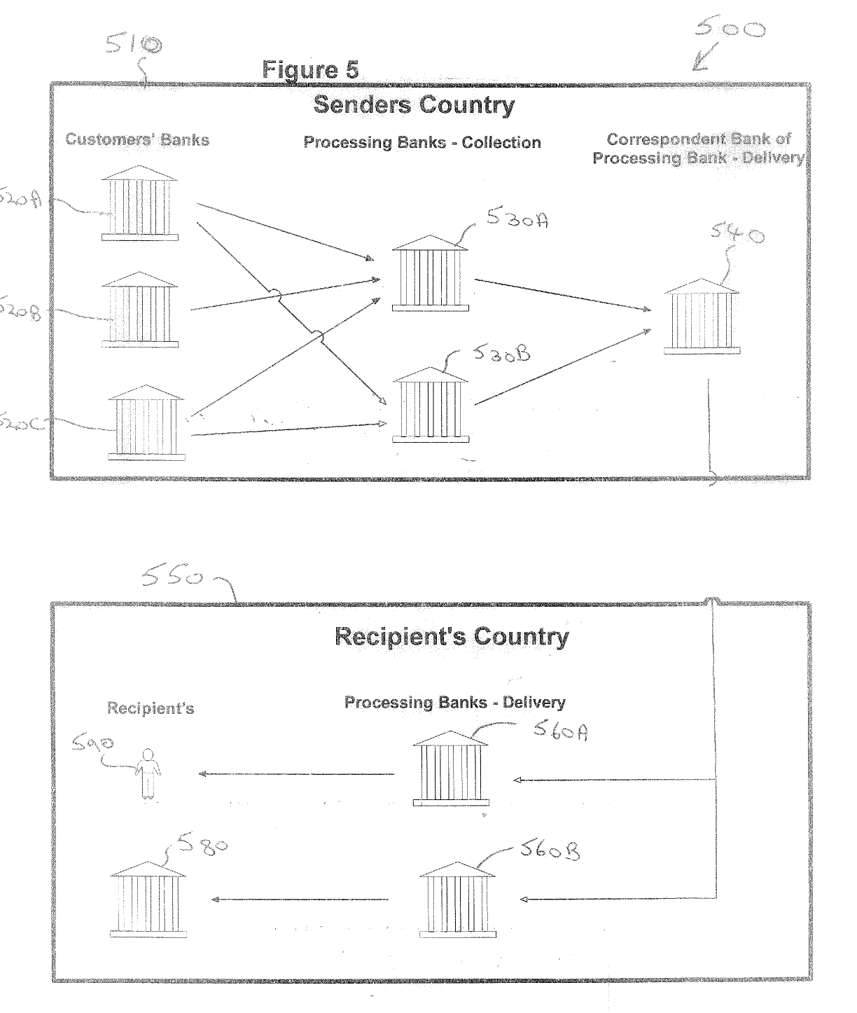

Turning now to FIG. 5, a flowchart 500 of the movement of funds being transferred between the sending country 510 and the receiving country 550 is shown. From a monetary funds flow perspective, the processing banks 530A, 530B collecting funds from the customers banks 520A, 520B and 520C move funds from the customer banks source accounts, aggregate these funds and move those funds to an account of the processing bank 540 delivering the transfer.

The processing banks 560A, 560B delivering to the recipients will determine if the funds from the collecting processing bank 540 have been credited to its account. The delivering processing bank 560A, 560B can use a wide variety of methods to validate the deposit to its account. After being credited, the collecting processing bank 560A, 560B processes and delivers the recipient transactions. Collecting processing bank 560A is shown delivering funds to a recipient 590. This transfer can be directly to an individual recipient or can be through a courier service. Collecting processing bank 560B is shown delivering funds to a recipient bank 580.

An example of a funds transfer will now be presented. Customer A desires to send $100 to a recipient in the Philippines. The transfer can occur the next day. The transfer is to be sent in the local currency and deposited in the recipients' bank account.

The customer initially creates and validates an account using steps 210-224 of FIG. 2. Next, the customer designates an amount to transfer and the date of transfer using steps 312-338 of FIG. 3.

The next day, the international funds transfer system 100 recognizes the transfer needs to be processed that day. System 100 then applies the current exchange rate for the recipient's currency (step 412, FIG. 4). For this example, the local currency has an exchange rate of 25 for every $1.00. The system converts the $100 to 2500 units of local currency.

The system then checks the senders and recipients name against the sender's country's money laundering and terrorist lists (step 416, FIG. 4). Once the names are verified not to be on the list, the transfer is sent for processing. If one of the names is on the list, the transfer is flagged and the sender's government is informed of the transfer. The actual disposition of the transfer is determined by each country's laws and regulations.

A source transaction is then created using the senders name, account information and the amount sent in the sender's currency ($100) for processing through the senders banking system (step 420, FIG. 4). Using the embedded business rules, this source transaction is routed to the most appropriate processing bank for funds collection (steps 428, 431 and 432, FIG. 4). Once received by the processing bank, the funds are collected. The processing bank then forwards the funds to the processing bank at the recipient's country.

Simultaneously a recipient transaction is created using the recipient's name, address, the amount converted to the recipients' currency (2500) and other information (step 420, FIG. 4). The recipient transaction is routed to the most appropriate processing bank in the recipient's country (steps 446, 448 and 450, FIG. 4). Once the transaction is received, the recipient bank checks their account for a credit of $100. Once the credit is verified, the deposit to the recipient's bank account is made.

The funds transfer system 100 is implemented in software that runs on host computer 65 (FIG. 1). The software uses conventional web application architecture, and conforms to the Model-View-Controller design pattern, with data structures modeled as Java objects, view components implemented as java server pages (JSP), and business logic embedded in Java beans and servlets. Sun Java 2 standard 1.4.2+ can be used along with Tomcat 4.1+ and JBoss 3.2+.

The system stores all data utilized in customer and internal operations in an Oracle 10 g relational database management system (RDBMS). Database connections are established via the use of Oracle's pure Java thin driver. This is a fast, lightweight driver that can access metadata as well as normal structured query language transactions.

Relational persistence is managed in the application through the use of Hibernate 2.0+, an open-source persistence management scheme that models data structures as POJOs (Plain Old Java Objects) rather than Enterprise Java Beans (EJBs). Hibernate features XDoclet generated remote and home interfaces, and can be synchronized with associated data tables or views automatically at build time. XDoclet regenerates the associated interface components by changing the underlying object; the changes are propagated throughout the object's interfaces and methods.

The system implements Session EJBs for session tracking, logging and management, but relational persistence in the application server is not managed with EJBs.

The system's web application uses Apache Struts 1.1 application framework. Struts is another open-source component that provides a set of tag libraries and Java classes that manage website navigation, form handling and validation, error handling and data-driven content. Apache Struts encourages the use of reusable components and provides flexible and powerful access to bean methods and fields. Struts facilitates the use of the Model-View-Controller design pattern which has become the dominant design paradigm of web applications.

Conclusion

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A system that transfers funds from a remitter to a beneficiary, comprising:
(A) a customer interface system for allowing the remitter to create, validate and initiate a remittance transaction;
(B) a host computer system in communication with the customer interface system, the host computer system being adapted to receive the remittance transaction from the customer interface system and to transmit the remittance transaction;
(C) an originating financial institution financial system in communication with the host computer system, the originating institution financial system receiving the transmitted remittance transaction from the host computer system, the originating financial institution financial system further processing the remittance transaction and transmitting funds; and
(D) a receiving financial institution financial system in communication with the host computer system, the receiving institution financial system receiving the transmitted remittance transaction from the host computer, receiving the funds from the sending financial institution financial system and providing the funds to the beneficiary.

2. The system according to claim 1, wherein the host computer system does not receive the funds being transferred.

3. The system of claim 1 wherein, the host computer system receives data about a first amount to be transferred in a first currency and calculates a second amount to be transferred in a second currency, the host computer system transmitting the second amount to the receiving institution financial system.

4. The system of claim 1 wherein the host computer creates and stores a source transaction file and a recipient transaction file, the source transaction file being transmitted to the originating financial institution financial system and the recipient transaction file being transmitted to the receiving financial institution financial system.

5. The system of claim 1 wherein the remittance transaction can be scheduled to repeat at pre-determined dates in the future.

6. The system of claim 1 wherein the system checks the remittance transaction against a database of prohibited senders and recipients.

7. The system of claim 1 wherein the system determines a processing fee to be sent to the receiving financial institution and generates a reporting file that is transmitted to the originating financial institution.

8. A funds transfer system comprising:
(A) a processor;
(B) a memory system in communication with the processor;
(C) software residing in the memory system and operable on the processor to:
(D) receive financial account information from a first user;
(E) validate the financial account information associated with the first user;
(F) receive a transfer request from the first user to transfer funds from a first account to a second user;
(G) transmit the transfer request to at least one originating financial institution to perform the fund transfer request;
(H) transmit the transfer request to at least one receiving financial institution to receive the funds for the second user; and
(I) allow the originating financial institution to transfer finds from the originating financial institution to the receiving financial institution.

9. The system according to claim 8, wherein the funds transfer system does not receive the funds being transferred.

10. The system of claim 8 further comprising:
(A) creating and storing a source transaction file;
(B) creating and storing a recipient transaction file; and
(C) transmitting the source transaction file to the originating financial institution and the recipient transaction file to the receiving financial institution.

11. The system of claim 8 further comprising:
(A) receiving data about a first amount to be transferred in a first currency;
(B) calculating a second amount to be transferred in a second currency;
(C) transmitting the second amount to the receiving financial institution.

12. The system of claim 11 further comprising:
(A) accessing a currency exchange database; and
(B) retrieving at least one currency exchange rate from the currency exchange database.

13. The system of claim 8 wherein the first user enters financial account information into the system through the internet.

14. The system of claim 8 further comprising:
(A) calculating a processing fee for the receiving financial institution to process the fund transfer;
(B) transmitting a request to the originating financial institution to transfer the processing fee to the receiving financial institution.

15. A method of transferring finds comprising:
(A) receiving financial account information from a sender, the financial account information including information about the sender and a recipient;
(B) validating the financial account information;
(C) receiving remittance instructions from the sender to initiate a fund transfer transaction;
(D) issuing payment instructions to at least one originating financial institution to perform the fund transfer transaction;
(E) notifying at least one receiving financial institution of the payment instructions associated with the fund transfer transaction; and
(F) allowing the originating financial institution to transfer the funds to the receiving financial institution;

16. The method of claim 15 further comprising: calculating an amount to be transferred in a second currency.

17. The method of claim 16 further comprising: providing the amount to the recipient in the second currency.

18. The method of claim 15 further comprising:
(A) calculating a processing fee for the receiving financial institution to process the fund transfer;
(B) transmitting a request to the originating financial institution to transfer the processing fee to the receiving financial institution.

19. The method of claim 15 wherein, the remittance instructions include scheduling more than one fund transfer transaction.

20. The method of claim 15 wherein, the financial account information is validated by communicating with at least one financial institution.
